(19) United States
(12) Patent Application Publication
(10) Pub. No.: US 2004/0060334 A1
(43) Pub. Date: Apr. 1, 2004

(54) Acid gas enrichment process

(76) Inventor: Gary Palmer, Calgary (CA)

Correspondence Address: THOMAS E. MALYSZKO, SUITE 1500, 250 - 6 AVENUE, S.W., CALGARY, T2P 3H7, CA

(21) Appl. No.: 10/671,664

(22) Filed: Sep. 29, 2003

(30) Foreign Application Priority Data
Sep. 27, 2002 (CA) 2,405,719

(51) Int. Cl. C05D 1/00

(52) U.S. Cl. 71/31

(57) ABSTRACT

Processes for enriching acid gases for sulphur plant feeds and for producing a commercially valuable CO₂ by-product include a sour gas stream contacting an absorbent in an absorber, and regenerating the absorbent to produce a regenerated absorbent and an acid gas stream. A portion of the acid gas stream is recycled to produce higher ratios of hydrogen sulphide to carbon dioxide. Multiple absorbers and recycle streams can be used.

### FIELD OF THE INVENTION

The present invention relates to treatment of natural gas generally, and in particular relates to processes for enriching acid gases for sulphur plant feeds and for producing a commercially valuable CO₂ by-product.

### BACKGROUND OF THE INVENTION

a) Industry Background

Petroleum reservoirs, whether primarily oil reservoirs or gas reservoirs, often contain significant quantities of hydrogen sulphide (H₂S) and carbon dioxide (CO₂) in addition to hydrocarbons. These contaminants must be removed or at least reduced to meet commercial specifications for purity before the natural gas can be marketed to consumers. The hydrogen sulphide and carbon dioxide, usually referred to as “acid gases”, have commercial value as by-products in and of themselves if, for example, the hydrogen sulphide is converted to sulphur and the CO₂ is used for miscible flooding of oil reservoirs. Otherwise, the acid gases are considered to have no marketable value, and are disposed of either by pumping down a disposal well or by flaring.

Commercial specifications for natural gas require that essentially all of the hydrogen sulphide be removed from the gas, typically to a final concentration of 4 PPM (parts per million) by volume or less. Carbon dioxide must likewise be reduced, but being non-toxic, the tolerance for CO₂ is much higher (typically 2% by volume for commercial pipeline quality gas).

The extremely stringent specification for H₂S content in natural gas has dictated the type of process that must be used, and virtually all natural gas being “sweetened” today is treated by one of the various alkanolamines that are available for this purpose. More than half a century ago, the Girbitol process was introduced in which the primary amine, monoethanol amine (popularly known as “MEA”), was used as the absorbent. Since then, other amines have become popular, namely diethanoamine (DEA), and a current favourite, methyldiethanol amine (MDEA), which is popular because of its preferential affinity for hydrogen sulphide over carbon dioxide. In most cases, generic amine in an aqueous solution is used, although various processes are available in which chemical additives are used in the amine solution to enhance certain characteristics of the absorbent. Amine has gained widespread acceptance and popularity because it can produce a natural gas product that reliably meets the strict requirements for gas purity, especially the requirements for hydrogen sulphide, and can do it relatively inexpensively.

Alternative processes for acid gas removal, such as physical absorption in a solvent or distillation for removal of acid gases, have not been used extensively, except possibly for bulk removal followed by cleanup with amine. Amine is able to remove acid gas components by reacting with them, which in an equilibrium situation can potentially totally remove the acidic components from the gas. Acid gases can be removed by other processes based on chemical reaction, such as the hot carbonate process and various forms of the iron oxide process, which can meet the specifications for gas purity. However, for many practical reasons these processes have never gained widespread popularity.

Historically, the primary concern of the gas processing industry has been to produce natural gas that will meet the stringent requirements for gas purity imposed by pipeline and distribution companies who establish the specifications for natural gas. There has been much less attention directed toward the by-product of the amine process—the acid gas mixture of H₂S and CO₂ that is co-absorbed in the process. Typically, these two gases are not subjected to any separation process to recover them as two separate entities, but are sent directly as feed to a sulphur plant.

Most sulphur plants utilize some version of the Claus process in which one third of the H₂S is oxidized by combustion to SO₂, which then subsequently reacts with the remaining two thirds of the H₂S to produce elemental sulphur and water. The second acid gas component, carbon dioxide, is an inert gas and a none-participant in the chemical reaction, but because of the thermodynamics of the Claus process, carbon dioxide will detrimentally affect the reaction to produce sulphur. The presence of carbon dioxide dilutes the reactants—hydrogen sulphide, oxygen, and sulphur dioxide—, retarding the reaction and reducing the percentage conversion to sulphur. The dilution effect directly influences the chemical equilibrium of the Claus process, fundamentally reducing the attainment of high rates of sulphur conversion. In cases where the acid gas feed to the sulphur plant is rich in H₂S, the effect of dilution by CO₂ may not be too serious, but in those cases where the quantity of CO₂ exceeds the quantity of H₂S by a factor of five or more, the effect on thermodynamic equilibrium conversion to sulphur is very significant.

A secondary effect of dilution of H₂S by excessive quantities of CO₂ is flame stability in the reaction furnace where H₂S is oxidized to SO₂. Carbon dioxide is an effective fire extinguishing chemical, and when present in excessive amounts in the reaction furnace it can inhibit combustion, and in some cases completely quench the flame. The dilution effect of CO₂ in the firebox of the furnace will also reduce furnace temperature to the extent that complete combustion does not occur. This necessitates the addition of natural gas to the acid gas entering the sulphur plant in order to improve combustion and maintain flame temperature in the reaction furnace. Natural gas in the reaction furnace causes a further complication by increasing the undesirable reaction by-products, carbonyl sulphide and carbon disulphide. These are the products of reaction between methane and other hydrocarbons, CO₂, H₂S and oxygen, and although they may be present in the furnace effluent in concentrations of less than 1%, they effectively bind up a portion of the sulphur which does not completely hydrolyze back to H₂S in the catalyst beds of the sulphur plant, thus reducing the overall conversion of H₂S to sulphur.

It is apparent that there is a clear need for a process that will increase the concentration of H₂S in the feed gas entering a sulphur plant. Preferably the process should improve the conversion of H₂S to sulphur, and should also solve many of the operational problems associated with feed gases that are too lean in H₂S.

b) Relevant Technology

Advances toward improvement of H₂S/CO₂ ratios in sulphur plant feed have generally been based on the selectivity of methyldiethanol amine (MDEA) for H₂S over CO₂ when in contact with sour gas. Tertiary amines such as MDEA and also di-isopropyl amine (DIPA) exhibit this preferential affinity for H₂S. Other amines such as MEA and DEA tend not to exhibit significant preferential affinity, and will therefore strongly absorb both H₂S and CO₂.

In studying the relative affinities between tertiary amines and the acid gases hydrogen sulphide and carbon dioxide, two things must be considered. One is reaction equilibrium, which is defined as the final concentrations of reactants and reaction products after sufficient time has elapsed to attain steady levels. Equilibrium in thermodynamic terms occurs when the total free energy of the mixture reaches a minimum. The second thing to consider is reaction kinetics, which refers to the rate at which a reaction occurs. While consideration of reaction equilibrium is important, in the practical application of industrial chemistry, consideration of reaction kinetics is equally important since reaction time will greatly influence the final distribution of components in a reaction mixture. Such is the case with the tertiary amines, and also with DIPA. While the reaction with H₂S is rapid, the reaction with CO₂ is slow. Therefore, although consideration of reaction equilibrium alone would suggest that both H₂S and CO₂ could react almost to completion, when the reaction kinetics are considered, only the H₂S reaction approaches completion, while the CO₂ reaction goes only part way. Selective absorption of H₂S can therefore be improved by limiting contact time. The mechanical design of contacting equipment, the operating conditions, and the presence of special chemical promoters can all have a bearing on selectivity of tertiary amines for H₂S over CO₂.

The popular amines MEA, DEA, MDEA, DGA, and DIPA all have in common a trivalent nitrogen atom to which are attached alcohol radicals (either ethanol or propanol). For example, the primary amine, monoethanol amine, has one ethanol group and two free hydrogen atoms. The secondary amine, diethanol amine, has two ethanol groups (as the name suggests) and one hydrogen atom. DGA has a single ether-ethanol chain with two hydrogens. MEA, DEA, and DGA all react rapidly with carbon dioxide, combining with the available proton of the amine molecule to form a carbamate radical (see FIG. 1). DIPA, which has two propanol structures and a single hydrogen atom, is not fully substituted, and is therefore not a tertiary amine. DIPA does not exhibit the rapid reaction with CO₂ that is characteristic of the primary and secondary amines, each of which have an available proton. Apparently, the proton is not available for reaction with CO₂, so the carbamate reaction does not occur readily with DIPA. Hindered amines such as FLEXSORB or AMP solvent behave in the same way. Methyl diethanol amine (MDEA) is a tertiary amine which has no proton attached to the nitrogen atom. As the name suggests, the three valences of nitrogen are occupied by two ethanol groups and one methyl group, so the carbamate reaction, which requires a labile proton, cannot occur.

The reaction between a molecule of MDEA and a molecule of CO₂ is somewhat more complex. When a CO₂ molecule is dissolved in an aqueous solution, due to its acid nature it hydrolyzes to form carbonic acid (H₂CO₃). In a process which occurs slowly, the carbonic acid then dissociates to form positive hydrogen ions and negative bicarbonate ions. The bicarbonate may, to some extent, dissociate further to form additional positive hydrogen ions and negative carbonate ions. The MDEA molecule, being mildly basic in character, will bond loosely with the available hydrogen ions to form a positively charged amine-hydrogen ion that coexists in solution with negatively charged bicarbonate and carbonate ions (see FIG. 2). Since the carbonic acid dissociation step is relatively slow kinetically, the overall sequence of steps must also proceed slowly. The overall kinetic acid-base reaction between tertiary amines and carbon dioxide must therefore occur quite slowly. In contrast, the acid-base reaction of hydrogen sulphide occurs rapidly. In typical contacting devices, the H₂S reaction rate is at least ten times faster than the CO₂ reaction. These differential rates of reaction help to explain the selectivity of tertiary amines for H₂S over CO₂.

As the reaction between the amine and acid gas proceeds, more of the available amine molecules become bound to acid gas molecules, leaving fewer unreacted amine molecules available to react with the acid gas. This lack of available reactive amine molecules in the presence of acid gas slows the rate of reaction. Solution loading is therefore another factor influencing the selectivity of tertiary amines for H₂S.

Reaction kinetics, however, are only one factor to consider in analyzing the absorption of acid gases by amine solutions. As in physical absorption, acid gas molecules must migrate to the gas liquid interface under the action of the concentration gradient that exists in the gas film adjacent to the interface. The molecule must then penetrate the interface and migrate inward until an unreacted amine molecule is encountered. As the mass transfer of acid gas molecules from the bulk gas phase into the liquid phase occurs by diffusion, the process of transfer requires a finite amount of time. Diffusion in this case occurs in two sequential steps. First, diffusion through the gas phase occurs near the interfacial boundary at the gas diffusion rate and, second, diffusion through the liquid phase occurs near the liquid boundary of the interface at the liquid diffusion rate. As a significant factor in rate limitations for tertiary amines, mass transfer by diffusion must be considered in addition to chemical rates of reaction. It has also been observed that selectivity for H₂S increases as contact pressure decreases.

As previously mentioned, H₂S reacts almost instantly with amine, so mass transfer by diffusion through the gas phase is the rate-limiting step for hydrogen sulphide. For carbon dioxide, the dissociation to form hydrogen and bicarbonate ions proceeds so slowly that the concentration gradient in the liquid phase that drives the mass transfer is impeded. This impedance constitutes an additional resistance to absorption of CO₂.

Practical applications for the selectivity of tertiary amines for H₂S over CO₂ have, for the most part, been limited to absorption of acid gases from natural gas in a primary absorber (see FIG. 3 which shows a standard arrangement). Circulation rate and residence time in the absorber permit a portion of the CO₂ to remain unabsorbed while H₂S is totally removed from the gas. Commercial specifications for natural gas require near to total removal of H₂S, but in most cases up to 2% carbon dioxide in the purified gas is acceptable. The tertiary amine, methyldiethanol amine (MDEA), is usually the preferred absorbent. The practice of partially removing CO₂ from the natural gas is referred to as “slipping” the CO₂.

In the technical record, references to MDEA's preferential affinity for H₂S over CO₂ appear as early as 1950, when Frazier and Kohl first noted the phenomena (see Frazier, H. D. and A. L. Kohl, “Selective Absorption of Hydrogen Sulfide from Gas Streams”, Ind. Eng. Chem., 42, 2288-2292 (1950)). Since then, the technical literature has traced the development of design methods for the use of MDEA. By the 1980's MDEA had gained widespread use in the gas industry, but applications were generally restricted to the relatively simple operation of slipping a portion of the CO₂ in the high pressure absorber while totally absorbing the H₂S. The formidable challenges of quantitatively predicting the combined chemical reaction and mass transfer relationships were not met until recent years, and although present methods are adequate, there is still significant room for improvement.

Present methods involve computational procedures to establish both chemical and mass transfer equilibrium relationships between the amine and the acid gases. The concentrations of the various chemical species seek to arrive at final equilibrium concentrations at which point no further change will occur. It is the difference between actual concentrations and equilibrium concentrations that provides the driving force for change to occur. Because there are various resistances to these changes, change does not occur instantaneously; it occurs at a definite rate determined by the nature of the components, and by circumstance. Rate of change is proportional to driving force but inversely proportional to resistance, so if driving force and resistance can be calculated, the rate of change can also be calculated. If infinite time were available, equilibrium concentrations would eventually be attained. In reality, however, time constraints dictate that only a partial approach to equilibrium is attainable. This procedure forms the basis for the design of processing equipment to preferentially absorb H₂S from gases containing a mixture of both H₂S and CO₂.

Since H₂S proceeds toward equilibrium rapidly, it approaches equilibrium more closely than CO₂, which proceeds slowly. In real absorbers, equilibrium can be approached, but is never attained. In a multistage contacting device such as a trayed tower, if each actual stage had sufficient time to reach equilibrium, the stages would be said to be 100% efficient. This hypothetical scenario provides a measure of the change that takes place on each actual stage if the actual change is expressed as a percentage of the change that would take place if equilibrium were attained. The actual change taking place on the stage could then be calculated from the known (100%) efficiency of the stage when equilibrium is attained. For example, in a typical trayed MDEA absorber, the tray efficiency for H₂S is approximately 50%, whereas the tray efficiency for CO₂ is typically about one-tenth as much, or 5%. If this preferential effect is factored into multiple stages of contact, the separation of H₂S from CO₂ can be significant. In practical situations, however, it must be recognized that the final concentration of H₂S in the treated gas must be very low, while the concentration of CO₂ is many times higher. The driving force for absorption of H₂S is low, while the driving force to absorb CO₂ is relatively high in the top trays of the absorber tower. This means that, in the process of absorbing essentially all of the H₂S, significant quantities of CO₂ will inevitably also be absorbed, and that the rich MDEA exiting from the bottom of the absorber column will contain a large amount of CO₂ along with the absorbed H₂S.

Over the years various schemes have been proposed to improve the selectivity of tertiary amines for H₂S over CO₂, but unless the true complexity of the absorption process is recognized, the success of these schemes will be compromised. For example, many schemes attribute to the tertiary amines a strong similarity to physical absorption, in which acid gases are absorbed or desorbed in response to changes in pressure or temperature. Physical absorbents generally follow the principle of Henry's Law, which states that the concentration of a distributed component in the liquid phase is proportional to the partial pressure of the component in the gas phase. Due to chemical reactions that inevitably occur in the amine solution, amines do not behave in this manner. When the chemical bond between the amine and the acid gas is formed, it is not easily broken. Attempts to desorb the acid gases by pressure reduction, gentle heating, or gas stripping will therefore have only limited success. The only way to release significant amounts of acid gas from the amine solution is to break the chemical bond by vigorous steaming of the solution in the amine regenerator. Some proposed process schemes are based on mild partial regeneration to create a semi-lean amine solution, which, because it is supposedly already loaded with CO₂, will resist further absorption of CO₂, and absorb H₂S instead. Such schemes have proven impractical.

### SUMMARY OF THE PRESENT INVENTION

The process of the present invention recognizes that coabsorption of CO₂ and H₂S by tertiary amines is essentially unidirectional and that, short of vigorous regeneration of the rich solution by steaming, desorption of acid gas from rich solution is not significant. Absorption responds to partial pressures, solution loading, and temperature. However, because the chemical bond formed during absorption cannot be easily broken, in practical situations desorption will not respond to these measures.

The present process is most applicable to situations where the CO₂/H₂S ratio in the natural gas (indicated by reference numeral 10 in FIGS. 4 to 7) that feeds into the plant is relatively high. In this scenario, a rich amine solution exiting the high pressure absorber would therefore also have a relatively high ratio of CO₂ to H₂S, even if CO₂ slipping were used. In addition, because regeneration strips essentially all of the acid gas from the solution, the regenerator overhead vapour in a conventional MDEA plant would also have a high CO₂ to H₂S ratio. This invention proposes to improve this ratio by recycling an acid gas slip stream, which is rich in H₂S, to contact the rich amine prior to regeneration where, because of the higher partial pressure of H₂S in the recycled acid gas, further absorption of H₂S into the rich solution can occur. The source of the H₂S enriched acid gas is the overhead vapour from the regenerator. If a sufficient portion of this overhead vapour is recycled, the rich amine solution will be enriched in H₂S and, since the regeneration process strips essentially all acid gas from the rich solution, the regenerator overhead vapour will also be H₂S-enriched. A portion of this enriched overhead vapour is recycled back to enrich the amine solution, and the entire system will come to a new dynamic equilibrium based on these new conditions, resulting in regenerator overhead vapours having a significantly higher proportion of H₂S over CO₂.

In summary, the following process concepts form the basis of the invention.

(1) Tertiary amines exhibit a preferential affinity for H₂S over CO₂ primarily because of differing rates of absorption. Therefore, when H₂S and CO₂ are coabsorbed from gases, the relative proportion of H₂S to CO₂ in the amine will be higher than the corresponding proportion in the gas phase. This is because in the actual processing equipment H₂S is absorbed more rapidly than CO₂.

(2) Absorption of acid gas by amine involves physical absorption plus chemical reaction. Absorption occurs readily, but desorption to separate the acid gas from the amine is much more difficult because the reaction that bonds the acid gas chemically to the amine is not easily reversed except by intense steaming at elevated temperature. Mass transfer of acid gas is therefore essentially unidirectional throughout most of the process except for the regeneration where the chemical bond that links acid gas to amine is broken by steaming the rich solution. After regeneration the amine is totally stripped of all acid gas except for very minor residual amounts.

(3) Rich tertiary amine in contact with sour gas will be loaded with both H₂S and CO₂ in proportions dictated by the ratio of H₂S to CO₂ in the gas phase, by the contact time and by the conditions of contact. While the rich solution does not readily give up its acid gas short of vigorous regeneration, it is possible to more fully load the rich solution with H₂S when the solution is in contact with a gas which is enriched with H₂S when the solution is in contact with a gas which is enriched with H₂S at the proper operating conditions.

(4) If the tertiary amine is initially contacted with gas that is relatively lean in H₂S but rich in CO₂, the H₂S will be totally absorbed, but a portion of the CO₂ will remain unabsorbed and will not be removed from the gas. This is referred to as “slipping” a portion of the CO₂. If the rich amine from the first contact is then contacted with the second gas that is richer in H₂S than the first gas, then the rich amine is capable of absorbing additional H₂S from the second gas, provided that concentrations and operating conditions are favourable.

However, the rich amine which contacts the second gas is not capable of totally removing the H₂S from the second gas because it is already partially loaded with H₂S. Equilibrium conditions between the rich amine and the second gas will permit only partial absorption of the H₂S, but will not permit total removal. Thus, while slipping CO₂ from the second gas, a portion of the H₂S will also be unavoidably slipped while in contact with the rich amine. In order to pick up the slipped H₂S from the second gas, the second gas must be contacted with lean amine which is sufficient to absorb the H₂S but will continue to allow the CO₂ to slip. The second gas, after being contacted by both rich and lean amine streams, will consist of substantially pure CO₂ after all the H₂S is removed.

(5) Based on the principles described in (4) above, it should be possible to extend the enrichment method by devising a multistage enrichment system wherein the acid gas is progressively enriched in stages by contacting rich amine with recycled acid gases that are progressively richer in H₂S in a series of absorbers and regenerators.

(6) It should be possible to realize some reduction in process heat required for regeneration of the rich amine solution by tailoring the acid gas residuals contained in the lean solution to suit the requirements of the individual absorbers. Absorbers with an extreme intolerance for acid gas residuals would be drawn from the bottom of the regeneration column where it would be exposed to the most intense degree of steaming. Absorbers with a greater tolerance for acid gas residuals could draw their lean amine from an intermediate stage in the column where the degree of regeneration heat is less. Overall, the two lean streams require less process heat than producing a single lean stream with very low residuals.

The above described principles recognize the physical and chemical nature that is inherent in tertiary amines. By employing these principles in combination it should be possible to devise a process that should greatly enrich the H₂S concentration of the acid gas feed to a sulphur plant. It should also produce a secondary benefit of producing a side stream of essentially pure CO₂ which may also have commercial value.

### BRIEF DESCRIPTION OF THE DRAWING FIGURES

Embodiments of the invention will now be described, by way of example only, with reference to the accompanying drawings, wherein:

FIG. 1 illustrates a carbamate reaction of an amine and carbon dioxide;

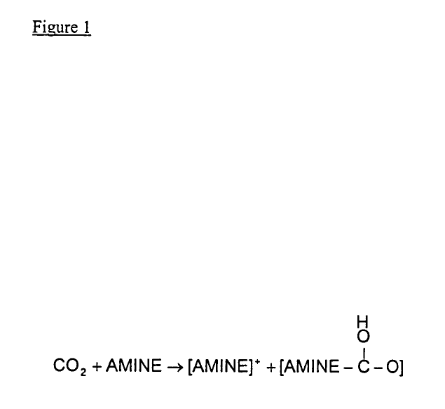

FIG. 2 illustrates a series of CO₂-tertiary amine reactions resulting in a positively charged amine-hydrogen ion;

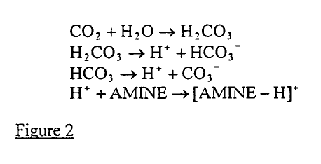

FIG. 3 shows a typical prior art amine process employing a primary absorber and regenerator;

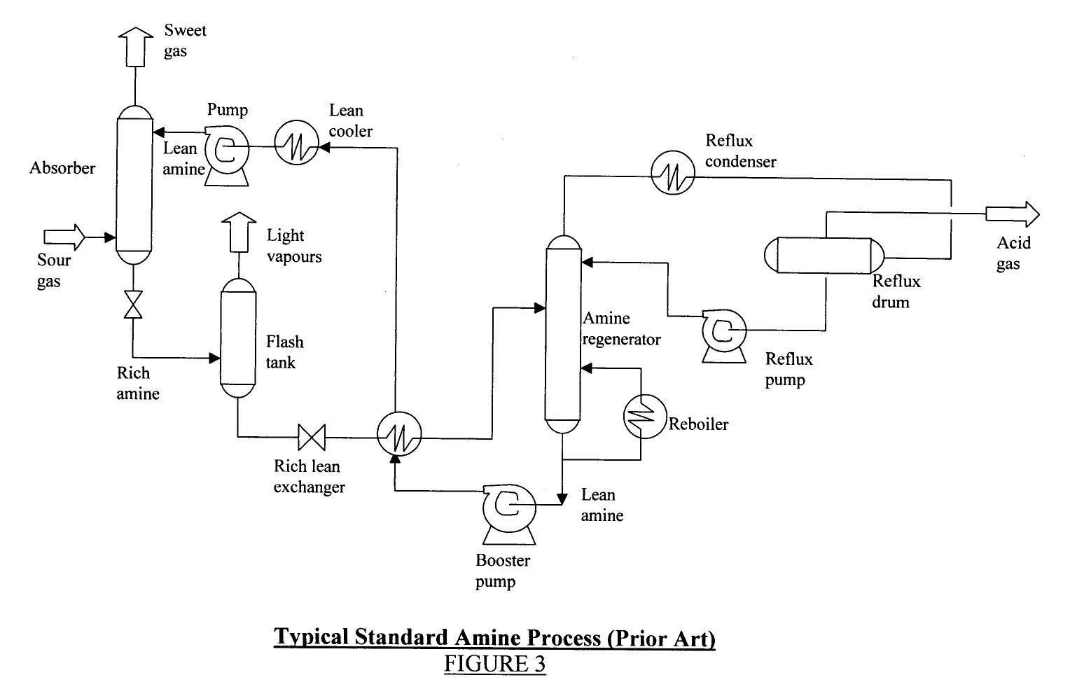

FIG. 4 shows a simple acid gas recycle process according to one embodiment of the present invention;

FIG. 5 shows a “single effect” acid gas enrichment process according to another embodiment of the present invention; and,

FIG. 6 shows a “single effect” process with a lean/superlean system according to a further embodiment of the present invention; and,

FIG. 7 shows a “double effect” acid gas enrichment process according to yet another embodiment of the present invention.

### DESCRIPTION OF PREFERRED EMBODIMENTS

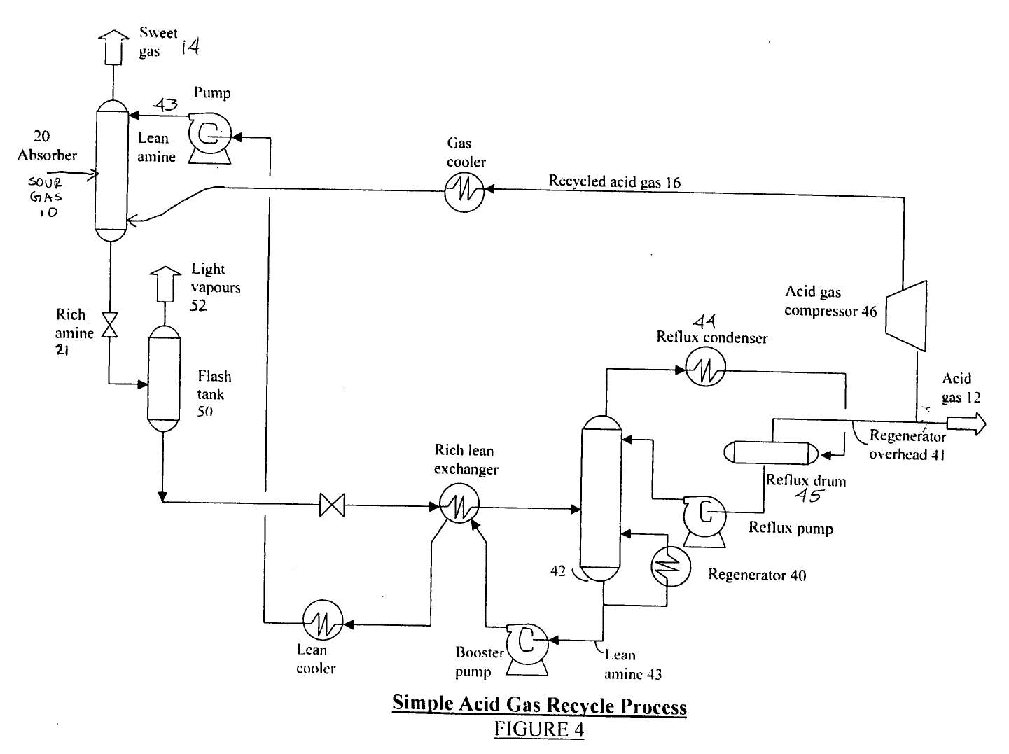

In one embodiment of the present invention shown in FIG. 4 there is illustrated a process of selective absorption of hydrogen sulphide over carbon dioxide from sour gas feedstock based on countercurrent contact between sour gas and tertiary or other amines which exhibit preferential affinity for H₂S over CO₂ primarily because of differential rates of absorption of the two gases. The process of enhanced selective absorption is accomplished by performing the absorption in two steps. The first operation is to contact lean amine 43 with a first incoming gas, namely sour gas 10, which contains both H₂S and CO₂. The object of the first operation is to produce a first outgoing gas, namely an overhead “sweet” gas 14, that meets an arbitrary standard for content of H₂S and CO₂. The second operation is to enhance the selectivity for H₂S by contacting the rich amine leaving the first operation with a second incoming gas 16 which is a highly concentrated “recycled” acid gas having a higher H₂S/CO₂ ratio than the sour gas 10. The contact with the recycled acid gas 16 occurs counter currently over a series of contact stages inside absorber 20 which causes the already rich amine to become even more heavily loaded with acid gas, but because of the high H₂S/CO₂ ratio of the recycled acid gas 16, the increased loading will be preferentially in favor of H₂S. The rich amine 21 leaving the second operation (also referred to herein as the first rich amine stream) will thus have a much higher proportion of H₂S relative to CO₂ than rich amine from the first operation, and when regenerated will therefore produce a regenerator overhead gas 41 that is likewise enriched in H₂S.

The lean amine 43 is introduced into the top end of the absorber 20 whereas the sour gas 10 is introduced into the absorber near its mid-point, where it comes into contact with the downward flowing amine. The recycled acid gas 16 is injected into the absorber 20 below the sour gas entry point near the bottom of the absorber where it contacts the already partially loaded amine solution flowing downward from the top of the absorber column. Due to the high concentration of H₂S in the acid gas, and because of the low concentration of inert gases, such as CO₂, it is possible to obtain a very heavy loading of H₂S in the rich amine 21 as it leaves the base of the absorber column.

The advantage of having the sour gas and recycled acid gas streams separately enter the absorber 20 is that the amine, while preferential toward H₂S, also absorbs CO2. If the acid gas recycle stream were mixed with the sour gas stream prior to entry into the absorber, there would be more CO₂ in contact with the lean amine than there would be were the recycled acid gas to be introduced at the bottom of the absorber, and so the CO₂ would occupy reaction sites that might have otherwise been used by H₂S, thus reducing the H₂S loading of the rich amine leaving the absorber.

The regeneration process, which incorporates the regenerator 40, strips essentially all of the acid gas from the rich amine, producing a regenerated lean solution 43 having only minor amounts of residual H₂S and CO₂. The regenerator overhead vapour contains the acid gases that have been stripped from the rich amine and will therefore have approximately the same H₂S/CO₂ ratio as existed in the rich amine. The source of the highly concentrated acid gas that contacts the rich amine in the second operation is the overhead vapour 41 from the regenerator after it has passed through a reflux condenser 44 and reflux drum 45. A portion of the vapour 41 is recycled back to the lower stages of the second operation as recycled acid gas 16, while the rest proceeds as a second outgoing gas, namely acid gas 12, to a sulfur recovery unit.

The H₂S enrichment process uses absorption to concentrate the amine solution preferentially with H₂S. Acid gases are bound to the amine by chemical reaction and this bond is not easily broken short of regeneration. The process preferentially loads the rich amine with H₂S by pairing up as many as possible of fast reacting H₂S molecules with amine molecules as quickly as possible, thus depriving the slowly reacting CO₂ molecules of active reaction sites and thus excluding them from the rich solution. The introduction of additional H₂S into the absorber column 20, however, means that conditions in the upper sections of the column must be altered in order to maintain H₂S specifications on the product gas 14 while slipping additional CO₂. Under conditions where the absorber 20 is operating at a high pressure, it can require significant power to drive the acid gas compressor 46 which is necessary to recycle the acid gas back into the absorber, so under those conditions this version of the inventive process may not be preferred over the alternative embodiments described below. With continued reference to the FIG. 4 embodiment, it is emphasized that the first and second operations take place within the same countercurrent absorption column 20 which operates throughout at essentially the same pressure. In the first operation as described above, lean amine 43 entering at the top of the upper section of the column comes in contact with sour gas 10 containing both H₂S and CO₂ which enters the column at an intermediate stage in the mid section of the absorber at the point where the first operation interfaces with the second operation. The first operation occurs in the upper section of the column and the second operation occurs in the lower section. Rich amine from the first operation flows downward into the stages of the second operation where it comes in contact with the highly concentrated “recycled” acid gas 16 having a higher H₂S/CO₂ ratio than the incoming sour gas 10 which causes it to be much more heavily loaded with acid gas. But because of the high H₂S/CO₂ ratio of the recycled gas 16, the rich solution becomes preferentially loaded with H₂S, resulting in a much higher H₂S/CO₂ ratio in the rich amine from the second operation than in the rich amine from the first operation. The non-absorbed acid gas components from the second operation flow upward into the stages of the first operation where they blend with the first incoming sour gas, contacting the down flowing amine and giving up their acid gas components as the gas flows upward to the top stage of the column. The “sweet” gas 14 exiting the top of the column should meet the required specifications for H₂S content. CO₂ in the overhead gas 14 will be the non absorbed CO₂ that was not picked up by the rich amine 21 exiting the bottom of the column. The combined actions of the first and second absorption operations will attain an internal balance in which the rich amine leaving the base of the column will be enriched in H₂S, while the CO₂ thus excluded from the rich amine solution will exit from the top of the column along with the sweetened gas from which the H₂S has been removed. A single lean amine feed 43 at the top of the first operation will in most cases be adequate, but in some circumstances multiple lean amine feeds may be advantageous.

Single Effect Process

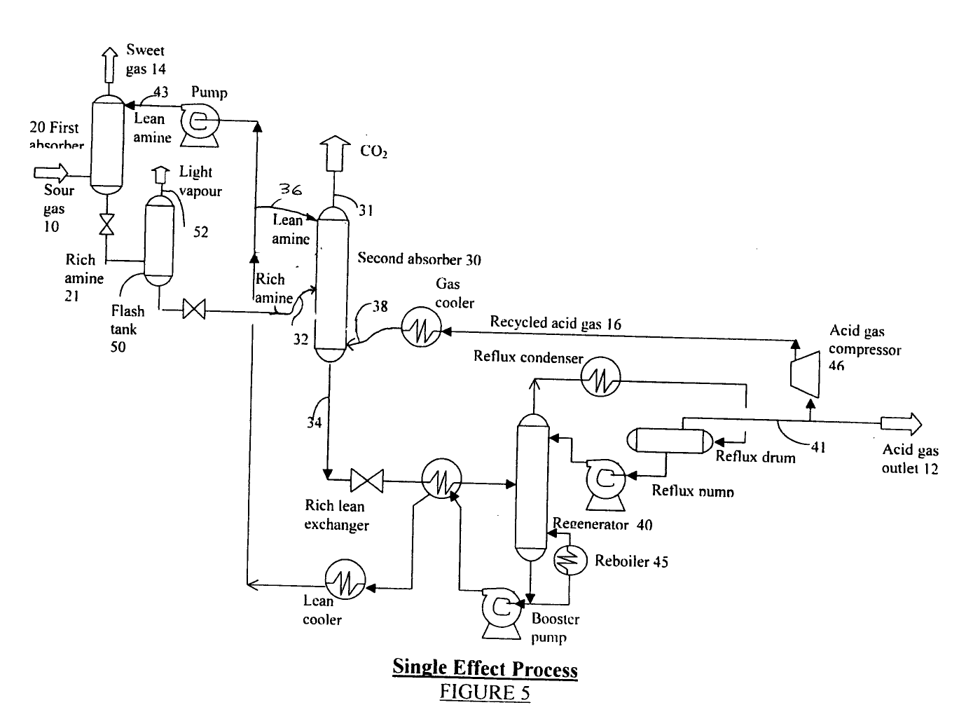

A second embodiment of the present invention shown in FIG. 5. illustrates a process which is sometimes referred to herein as a “single effect process”. A beneficial aspect of this process is that it employs a second absorber column 30 which operates at a pressure that is intermediate that of the main high pressure absorber tower 20, also referred to herein as the “first absorber”, and the low pressure amine regenerator 40. In this embodiment, the first and second operations referred to earlier take place in two different absorber towers operating at different pressures. The first operation, which typically operates at a higher pressure than the second operation, sweetens incoming sour feed gas 10 in the first absorber 20 to meet product specifications for H₂S. CO₂ is also removed, and by appropriate design methods it is possible, within limits, to control the amount of CO₂ removed. The second absorber tower 30 provides an additional degree of freedom in controlling the amount of CO₂ in the sweet gas product 14 from the first tower 20 by taking greater advantage of the amine's natural preference for H₂S.

The process of partially removing the CO₂ is referred to as “slipping” in which a portion of the CO₂ is permitted to exit with the sweetened product gas 14. Lean amine 43 enters the first absorber 20, picks up H₂S and a portion of the CO₂ and exits from the base of the column as rich amine 21. The rich amine 21 then flows to the second absorber 30 (which typically operates at a lower pressure than the first absorber 20) and enters at an intermediate stage, or midsection 32, between the top and bottom of the column. A highly concentrated “recycled” acid gas stream 16 with an enhanced H₂S/CO₂ ratio enters at the bottom stage or base 38 of the second absorber 30 where it flows upward into contact with downflowing amine solution (namely a blend of rich amine and lean amines). A portion of the downflowing amine solution is the rich amine 21 from the first operation, which, although already partially loaded with acid gas will become much more heavily loaded because of the concentrated acid gas 16 entering at the base 38 of the column. Because the acid gas 16 has an elevated H₂S/CO₂ ratio, the rich amine 34 leaving the base of the second absorber (also referred to herein as the second rich amine stream) will be preferentially loaded with H₂S.

Rich amine 21 from the first operation is capable of bulk absorption of acid gas, but because the amine is already partially loaded with acid gas, it is not capable of quantitatively absorbing the H₂S from the gas. Hence, vapours leaving the intermediate feed stage in the second absorber 30 will be mostly CO₂ but will also contain significant amounts of H₂S, which must be removed. Since it is desirable to produce an overhead vapour 31 from the second absorber that is essentially free of H₂S, it is necessary to contact the gas in the upper section of the second absorber 30 with a lean stream of tertiary amine 36 (directly from the amine regenerator 40) that enters on the top stage. The lean amine 36, having a very low residual H₂S content, is capable of removing essentially all of the H₂S from the acid gas stream, producing an overhead CO₂ vapour 31 (also referred to herein as the “second outgoing gas stream”) that is almost entirely free of H₂S and potentially marketable for various uses.

Light vapours such as methane and ethane, which may have been dissolved in the rich amine 21 from the first operation, will come out of solution at the reduced pressure of the second operation in the second absorber 30 and may contaminate the overhead stream 31 of CO₂. If these light vapours are objectionable in the CO₂ it is possible to exclude most of them by interposing a flash drum in the rich amine feed stream 21 upstream of the second column 30 where the reduced pressure of the flash drum will allow light dissolved vapours to evolve and be removed from the rich amine. The flash vapours will also contain minor amounts of H₂S and CO₂. Hence, in another aspect of the present process, a flash tank 50 is added to the system by locating it between the high pressure absorber 20 and the second absorber 30. The tank's purpose is to flash off non-condensable vapours, namely principally methane and ethane, which are picked up in small quantities in the high pressure absorber 20 where the amine acts as a physical solvent for hydrocarbons. These hydrocarbons are largely flashed off in the flash tank, along with minor amounts of H₂S and CO₂. This flash vapour exiting at 52 (also referred to herein as a “third outgoing gas stream”) can also be sweetened and used as plant fuel.

At the rich amine feed stage 32 of the second column 30, the partially loaded amine from the upper stages 36 of the absorber combine with the rich amine from the first column 20 and flow downward to the lower stages of the second tower. The overall operation of the first and of the second absorbers will reach an internal balance in which the rich amine 34 leaving the base of the second column 30 will be enriched in H₂S, while the CO₂ thus excluded from the amine will exit from the top of the second absorber as a water saturated CO₂ stream 31 essentially free of H₂S.

Multiple lean amine feed points 43 and 36 may be necessary on both the first and second absorbers 20 and 30, respectively, in order to optimize selectivity of the amine for H₂S under varying operating conditions.

The source of the concentrated acid gas 16 feed for the second absorber is a portion of the H₂S enriched acid gas overhead from the amine regenerator 40, which is compressed 46 and recycled back to the base of the second absorber.

The present invention is based on recycling a portion of the overhead acid gas stream from the regenerator 40 for the purpose of improving the ratio of H₂S to CO₂ in the acid gas stream 12 going to the sulphur plant. Carbon dioxide, which is an undesirable contaminant in the sulphur plant, is excluded at two points in the process. First, the CO₂ is only partially absorbed in the high pressure, absorber 20, allowing a portion of the CO₂ to slip and remain in the residue gas, namely the first outgoing stream 14 of “sweet gas”. Second, CO₂ is separated from the rich amine in the second absorber 30, where it is removed overhead at 31 as a second outgoing gas stream of essentially pure CO₂ and water. When the overall plant material balance for CO₂ is calculated, the concentration of H₂S in the overhead stream 41 from the regenerator 40 should be greatly increased, significantly improving its quality as a sulphur plant feed and improving the conversion of H₂S to sulphur in the sulphur plant.

Lean tertiary amine that leaves the regenerator 40 is split into two streams, namely a first lean amine stream 43 which flows to the top of the high pressure absorber 20, and a second lean amine stream 36 which flows to the top of the second absorber 30. The first stream 43 is sufficient to produce a sweet natural gas product, and the second stream 36 is used to sweeten recycled acid gas for the purpose of improving H₂S concentration in the feed 12 to the sulphur plant. This internal recycle system consisting of recycled enriched acid gas 16 requires additional lean amine 36, additional heat to regenerate the additional amine, and additional pumping and acid gas compression at 46 to recycle the internal streams. With this approach, additional process costs will be incurred in improving the H₂S/CO₂ ratio of the acid gas 12 leaving the plant, but these costs are reasonable and practical for most systems. However, with very lean streams, the acid gas ratio in the rich amine 21 from the high pressure absorber 20 will become increasingly unfavourable, and a greater and greater portion of the overhead regenerator vapour 41 must be recycled in order to gain a significant improvement in the concentration of H₂S in the acid gas stream 12 leaving the plant. In this case, the recycle stream 16 and the lean amine stream 36 going to the second absorber 30 become the dominant elements in the plant, resulting in potentially excessive process costs for reabsorbing and regenerating recycled streams.

Lean/Super Lean Amine Systems

It has been stated that in order to remove virtually all of the H₂S from a sour gas stream 10 while allowing a portion of the CO₂ to slip through an absorber, the lean amine solution must be stripped in a regenerator to a very low residual H₂S content. An H₂S content of 0.0015 mole percent is a typical H₂S residual for lean 50% (weight) MDEA. If residual H₂S rises much above this level, the H₂S content in the gas 14 exiting the top of the absorber will exceed acceptable limits. It has been found that the high pressure absorber 20 is much more tolerant of residual H₂S than the low pressure secondary absorber 30, even though the specification for H₂S in the gas from the high pressure absorber is much tighter than the specification for the low pressure absorber. The high pressure absorber can tolerate more residual H₂S because it has a much higher partial pressure driving force to cause H₂S to diffuse through the gas film at the liquid interface and into the body of the amine liquid. The low pressure absorber must function with a much lower H₂S partial pressure in the gas phase at the top of the column with the result that even modest amounts of residual H₂S in the lean amine inevitably create such resistance to diffusion that final traces of H₂S will not be absorbed and significant amounts of H₂S will break through with the gas exiting from the top of the second absorber.

In order to meet the strict requirements for low residual H₂S in the lean amine entering the second absorber 30 (which operates at a lower pressure than the first absorber 20), it is necessary to create a super lean amine by expending extra heat energy in the regenerator. The first absorber requires low residual H₂S, but because of its higher operating pressure, can tolerate residuals which are typically about five to ten times higher than those required for the low pressure absorber. Moderate steam stripping in the regenerator 40 is adequate to produce lean amine for the high pressure absorber, but for the low pressure second absorber intense steam stripping is necessary to produce a “super lean” tertiary amine having the required extremely low residual H₂S content. In a simple system, the single bottom product leaving the amine regenerator has been stripped of H₂S to the level necessary to meet the needs of the low pressure absorber, even though the high pressure absorber can tolerate a much higher level of H₂S residual in the lean solution.

Now, consider that in the amine regeneration still column the level of residual H₂S and CO₂ varies at different levels in the column. The lowest residuals are at the base of the column where the amine is subjected to the most intense steaming from the reboiler. Further up the still column, several stages above the reboiler, the amine's exposure to steam and temperature is lower, and the level of residuals in the solution is correspondingly higher. It is therefore possible to draw two lean streams of differing compositions from the regenerator.

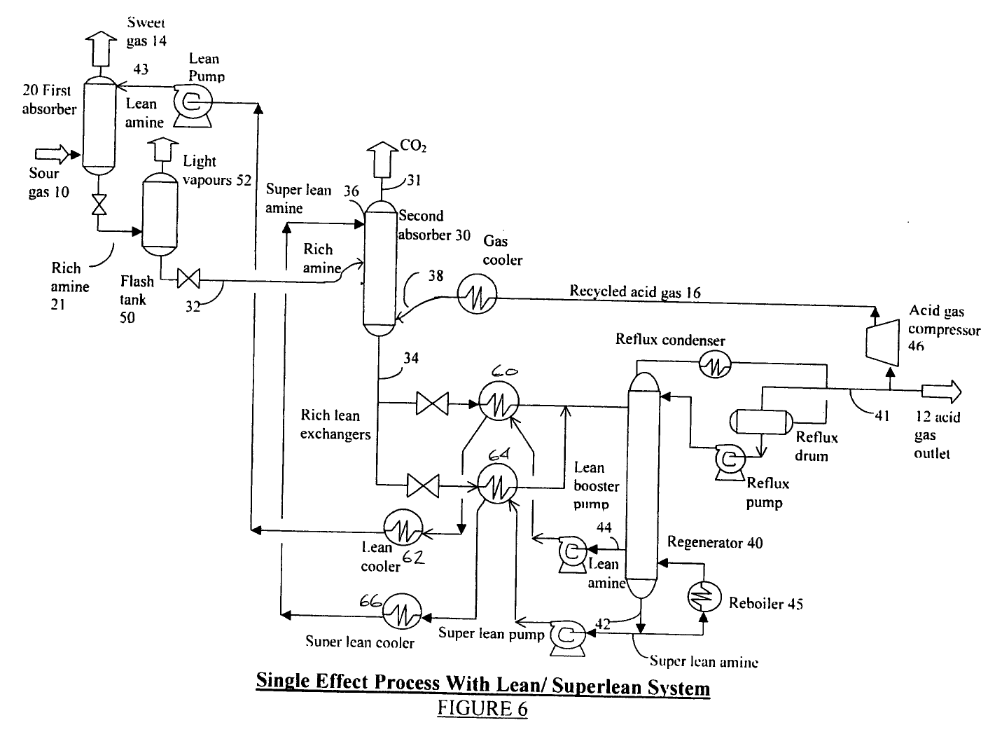

With the above in mind, the different requirements for lean amine purity for the two absorbers suggest an alternate arrangement for regenerating the amine solution as shown in FIG. 6. Instead of drawing all of the lean amine from the base of the regenerator still column, the lean amine for the high pressure absorber can be drawn at a first draw-off point 44 from an intermediate tray approximately five stages above the reboiler 45 located at the base of the column 40. The portion of lean amine drawn from the intermediate tray at 44 will have residual H₂S low enough to meet the needs of the high pressure absorber, while the balance of the amine remaining in the regenerator still column will continue to downflow over the trays in the lower section of the column where it is subject to the intense steaming necessary to regenerate a super lean solution at a second draw-off point 42 at the base of the regenerator suitable for the low pressure absorber. The two draw-off points 42, 44 in the still column serve to reduce the overall process heat necessary to regenerate the solution. Instead of expending the energy required to regenerate the total amine solution to the standard of purity required by the low pressure absorber, a lesser amount of energy is expended to regenerate a conventional lean amine for the high pressure absorber, plus a super lean stream for the low pressure absorber. This lean/super lean system is a relatively simple enhancement to the process that should improve overall energy efficiency by as much as 10 to 15 percent.

The flow scheme for the lean/super lean system is illustrated in FIG. 6. In this third embodiment of the invention there are two amine streams exiting from the regenerator, namely a lean steam and a super lean stream. The lean stream 44 is drawn from an intermediate stage in the regenerator 40 that is several stages above the reboiler 45 but is below the feed stream 34 which comes from the second absorber 30 to the top end of the regenerator. After leaving the regenerator, the lean stream 44 is cooled by flow through the rich/lean exchanger 60 and the lean cooler 62 after which it enters the first absorber as stream 43.

The super lean stream 42 exits from the bottom of the regenerator 40 in a customary manner and is pumped through the rich/super lean exchanger 64 and the super lean cooler 66 after which it enters the second absorber 30 as stream 36.

Extremely Lean Acid Gas—Double Effect Process

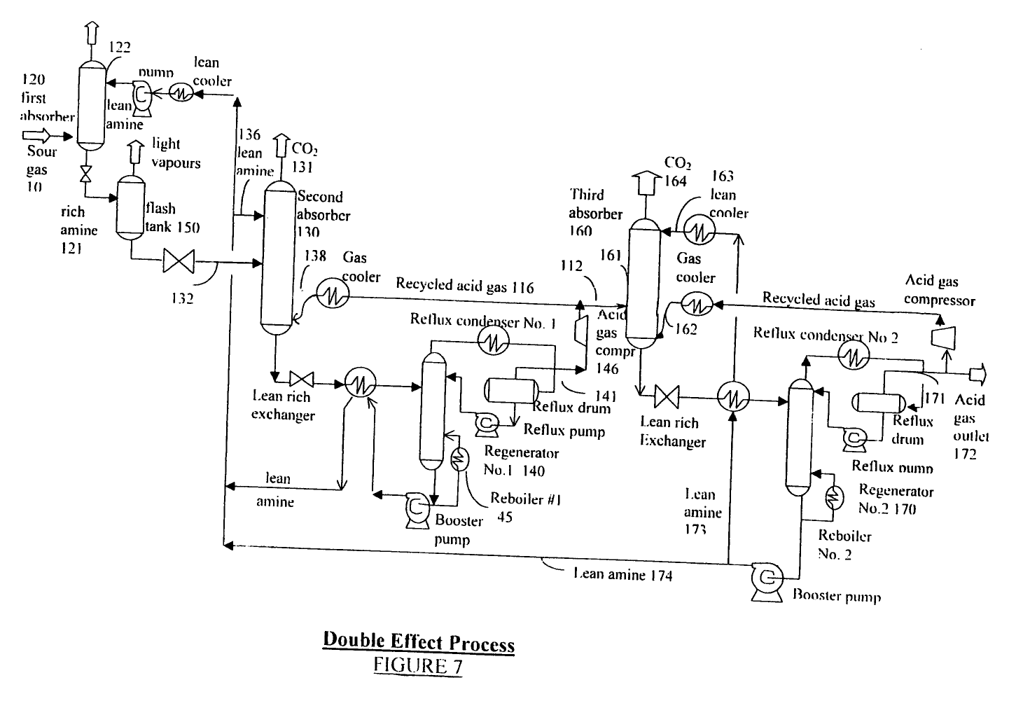

For extremely lean streams where, for example, the molar ratio of H₂S to CO₂ in the rich amine stream from the high pressure absorber is 1% or less, yet another, or fourth, embodiment of the invention shown in FIG. 7 should be considered. Low molar ratios exist where, for example, H₂S in the natural gas is 0.03%, while CO₂ is 5%. In spite of slipping CO₂ in the high pressure absorber, there will be a very strong predominance of CO₂ in the rich amine with a typical H₂S/CO₂ ratio of 1% or less. A 1% H₂S/CO₂ ratio as feed to a Claus sulphur plant following a conventional amine plant would be literally impossible to operate. Using the second embodiment of the invention (i.e. the single effect system) as described above, the H₂S/CO₂ ratio in the acid gas could be increased by a factor of about 5, or from 1% to 5%.

In applying the second embodiment of the invention to a system that is very low in H₂S, the acid gas recycled to the second absorber is still a comparatively lean gas, even though the H₂S has been concentrated by, for example, a factor of five. As the proportion of acid gas recycled is increased, the gain in concentrations of H₂S appears to approach a limit beyond which the amount of process energy expended becomes impractical. In this case, H₂S/CO₂ ratio can only be improved by employing a fourth embodiment of the invention shown in FIG. 7.

Whereas the second embodiment of the invention is referred to as a “single effect system”, the fourth embodiment of the system may be referred to as a “double effect system”, which involves coupling together two stages of low pressure absorption and regeneration. Components of the system in FIG. 7 which are the same or similar to those shown in FIG. 4 are identified with the same reference numerals, except with the addition of a prefix “1”. The double effect system consists of all the basic component parts of the single effect system, including the high pressure absorber 120, the optional flash tank 150, the second absorber 130, the regenerator 140, a compressor 146 to recycle acid gas, and a means of pumping lean amine to the two absorbers. The double effect system adds to the basic system a third absorber tower 160, a second regenerator 170, an additional lean amine pump 180, and an acid gas compressor 190.

The double effect system attaches directly to the acid gas outlet 112 from the single effect system. The acid gas enters near the base 161 of the third absorber 160, along with H₂S enriched acid gas at 162 recycled from the overhead 171 of the second regenerator 170. Lean amine from the second regenerator is divided into two streams: one stream 173 flows to the top of the third absorber at 163; and a second stream 174, which combines with lean amine from the first regenerator 140, flows to the top of the first absorber at 122 and the second absorber 136.

In the double effect system, greater concentrations of H₂S are achieved by rejecting a stream of essentially pure CO₂ and water overhead from the third absorber at 164. This CO₂, which is rejected from the process, may be combined with CO₂ from the second absorber 130. The second effect should improve upon the first effect's H₂S/CO₂ ratio by approximately a factor of three. The overall improvement in the ratio is therefore the product of the improvement in the first and second effects, which in the example cited is the product of 5 and 3. (If acid gas from the first effect has the H₂S/CO₂ ratio improved by a factor of 5, the overall ratio improvement leaving the second effect will be 15.) Thus, a H₂S/CO₂ ratio of only 1% should be improved to 15% in stream 172 by the use of a double effect system. A ratio of 15%, while still a relatively lean acid gas, is a practical concentration of H₂S for feed to a Claus sulphur plant. Individual cases will obviously vary, with final concentrations depending on initial concentrations, and the degree of recycling employed in the process.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below. For instance, it will be appreciated that the present process may be extended to a third effect or more, increasing the concentration of H₂S at each stage. For each succeeding effect, the feed into the low pressure absorber would be the acid gas produced by the preceding effect.

I claim:

1. A process for enriching acid gas for a sulphur plant feed as described and shown herein.
